(19) United States
(12) Patent Application Publication
(10) Pub. No.: US 2002/0009358 A1
(43) Pub. Date: Jan. 24, 2002

(54) Removable skid steer loader crane

(76) Inventor: Jonathan J. Fisher, Phoenix, AZ (US)

Correspondence Address: WEISS & MOY PC, 4204 NORTH BROWN AVENUE, SCOTTSDALE, AZ, 85251, US

(21) Appl. No.: 09/879,250

(22) Filed: Jun. 11, 2001

Related U.S. Application Data
(60) Provisional application No. 60/210,835, filed on Jun. 12, 2000.

(51) Int. Cl. B66C 23/00

(52) U.S. Cl. 414/686

(57) ABSTRACT

A device for allowing a skid steer loader to function as a small movable crane. The device has a boom member having a first end removably coupled to the skid steer loader. A load attachment mechanism is coupled to a second end of the boom member. The load attachment mechanism is used for attaching objects to the boom member to be lifted by the skid steer loader.

### RELATED APPLICATIONS

This patent application is claiming the benefit of the U.S. Provisional Application having an application number of No. 60/210,835, filed Jun. 12, 2001, in the name of John Fisher, and entitled “REMOVABLE SKID STEER LOADER CRANE AND METHOD THEREFOR”.

### BACKGROUND OF THE INVENTION

1. Field of the Invention

This invention relates to construction equipment, and more specifically, to a crane attachment that can be coupled to a skid steer loader thereby enabling the skid steer loader to gain the functionality of an extendable boom crane.

2. Description of the Prior Art

Skid steer loaders are prized because of their ability to perform a large number of tasks in a variety of locations having limited access. In order to accomplish these different tasks, skid steer loaders are designed to have a variety of removable and replaceable attachments coupled to their front ends. These attachments allow the skid steer loader to perform these variety of different functions. Some examples of attachments that may be coupled to the skid steer loader include, but is not limited to, front loader buckets, jack hammers, pallet forks, and drum clamps. However, a major deficiency with the skid steer loader has been the lack of a crane attachment. Presently, skid steer loaders do not have the ability to serve as a small movable crane. Present skid steer loaders do not have any attachments which allow it to serve the functions of a small moveable crane with an extendable boom.

Therefore a need existed to provide a mechanism to allow a skid steer loader to function as a small movable crane. The mechanism must allow a skid steer loader to serve the functions of a small moveable crane with an extendable boom.

### SUMMARY OF THE INVENTION

In accordance with one embodiment of the present invention, it is an object of the present invention to provide a mechanism to allow a skid steer loader to function as a small movable crane.

It is another object of the present invention to provide a mechanism that allows a skid steer loader to serve the functions of a small moveable crane with an extendable boom.

### BRIEF DESCRIPTION OF THE PREFERRED EMBODIMENTS

In accordance with one embodiment of the present invention a device for allowing a skid steer loader to function as a small movable crane is disclosed. The device has a boom member having a first end removably coupled to the skid steer loader. A load attachment mechanism is coupled to a second end of the boom member. The load attachment mechanism is used for attaching objects to the boom member to be lifted by the skid steer loader.

In accordance with another embodiment of the present invention a device for allowing a skid steer loader to function as a small movable crane is disclosed. The device has a support plate removably coupled to the skid steer loader. An extendable boom member is coupled to a hydraulic system of the skid steer loader and has a first end coupled to the support plate. A load attachment mechanism is coupled to a second end of the boom member and is used for attaching objects to the boom member for the skid steer loader to lift.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is an elevated perspective view of the removable attachment for allowing a skid steer loader to serve the function of a small moveable crane with an extendable boom.

FIG. 2 is a top view of the removable attachment for allowing a skid steer loader to serve the function of a small moveable crane with an extendable boom.

FIG. 3 is a side view of the removable attachment for allowing a skid steer loader to serve the function of a small moveable crane with the boom section extended.

FIG. 4 is a side view of the removable attachment for allowing a skid steer loader to serve the function of a small moveable crane with the boom section retracted.

FIG. 5 is an elevated rear perspective view of the removable attachment for allowing a skid steer loader to serve the function of a small moveable crane with an extendable boom.

FIG. 6 is a front view of the removable attachment for allowing a skid steer loader to serve the function of a small moveable crane with an extendable boom.

FIG. 7 is a side view of the removable attachment for allowing a skid steer loader to serve the function of a small moveable crane installed on a skid steer loader.

FIG. 8 is a side view of the removable attachment for allowing a skid steer loader to serve the function of a small moveable crane installed on a skid steer loader with a boom section extended and lifting a boulder.

### DETAILED DESCRIPTION OF THE PREFERRED EMBODIMENT

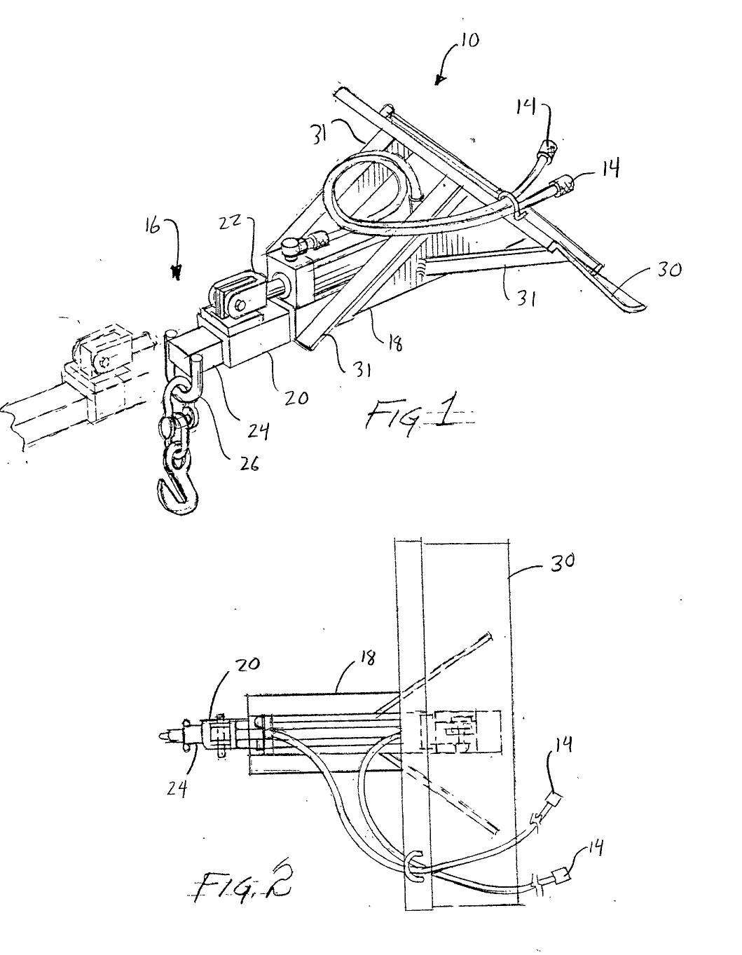

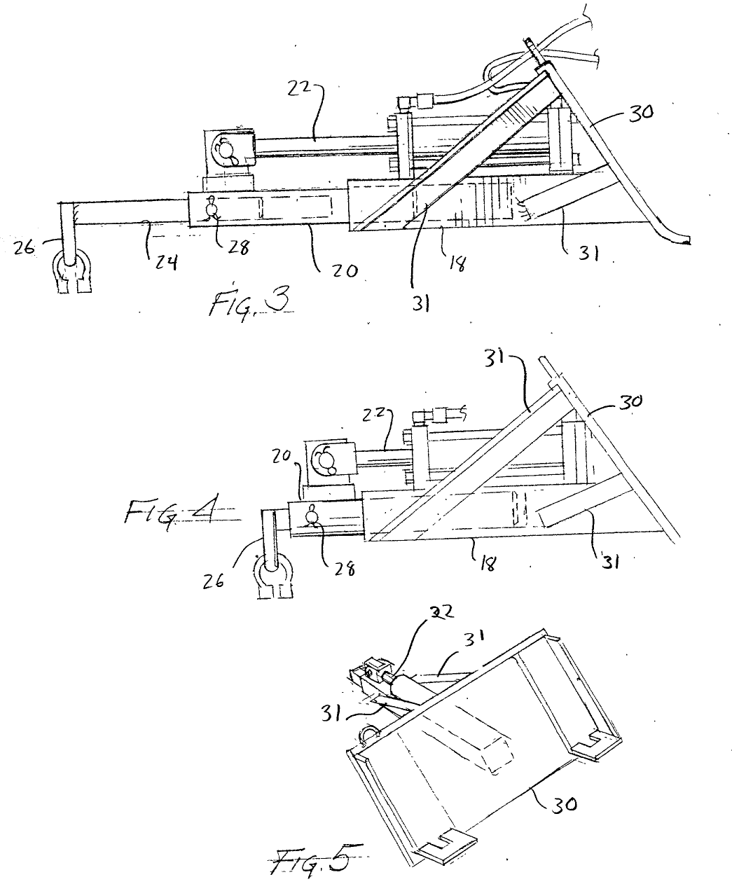

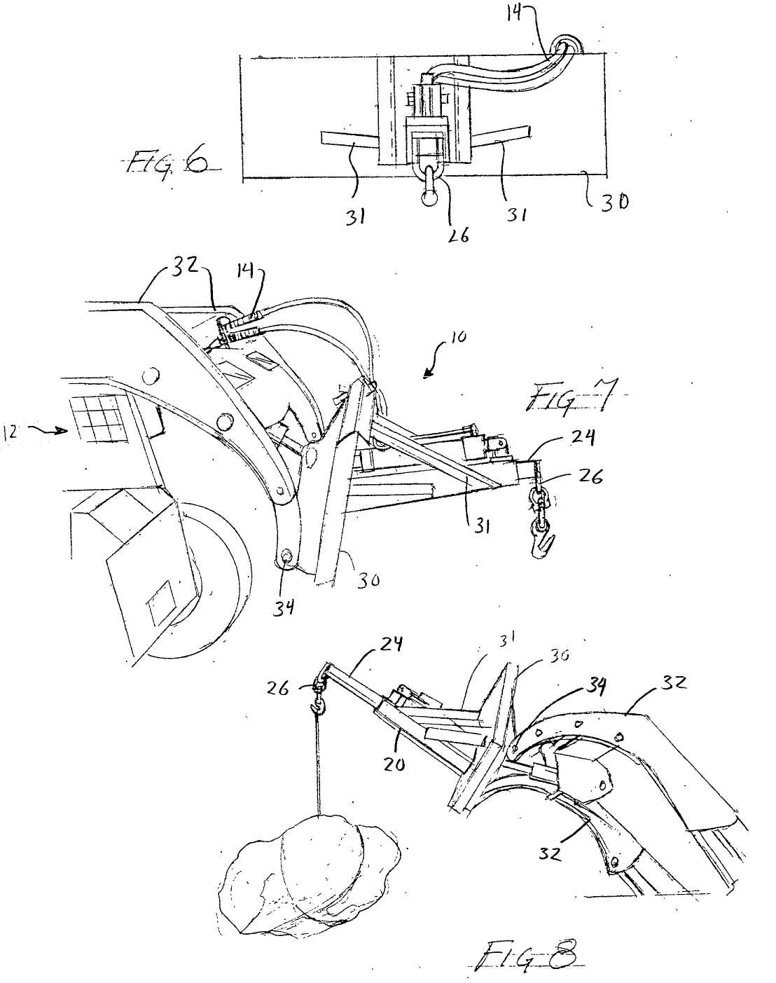

Referring now to FIGS. 1-8, a removable attachment device 10 (hereinafter device 10) is shown. The device 10 is coupled to a front end of a skid steer loader 12. The device 10 is used for allowing the skid steer loader 12 to serve the function of a small moveable crane. The device 10 of the present invention facilitates the reach and placement of heavy objects that can be attached to the skid steer loader 12 without obstructing the view of the operator of the skid steer loader 12. The present invention also allows access to confined or limited access areas due to the combination of the skid steer loader 12 and the relatively small boom area protruding out from the front of the skid steer loader 12 having a combined footprint that is relatively small.

The present invention is designed to maximize the lift potential of the skid steer loader 12 as well as to make the task of lifting heavy objects safer and more efficient. The device 10 couples to a skid steer loader 12 in place of some other removable attachment. The device 10 couples into the skid steer loader's hydraulic system 14.

The device 10 has an extendable boom section 16. The extendable boom section 16 on the skid steer loader 12 gives the operator an unobstructed view of a load that is being lifted. The extendable boom section 16 can be extended for greater reach capabilities.

The extendable boom section 16 has one or more independent booms that are designed to completely retract co-axially within the extendable boom section 16. The extendable boom section 16 has a main housing 18. The housing 18 is used for supporting and housing the extendable boom section 16 in a fully retracted position. A first extendable boom 20 is attached to a hydraulic ram 22 which can be connected to the skid steer loader's hydraulic system 14 that gives hydraulic control to the operator allowing them to extend and retract the first extendable boom 20.

A second extendable boom 24 is designed to completely retract inside the first extendable boom 20. The distal end of the second extendable boom 24 is typically where loads are attached when lifting. At the distal end of the second extendable boom 24 is a steel loop 26, or other suitable load attachment point, where attachments to a load is made by using cables, straps, chains, or like elements.

The second extendable boom 24 is also manually extendible. The second extendable boom 24 may be manually extended by pulling out a main pin 28, which is used to hold the second extendable boom 24 in place inside the first extendable boom 20, out of a first positioning hole. The second extendable boom 24 is then pulled out of the first extendable boom 20 to a desired length. The main pin 28 is then reset in another positioning hole. The positioning holes are drilled in even steps to allow partial or full reach potential. This gives the operator more control over the weight distribution of the load and makes the adjustment of the extendable boom section 16 safe and efficient.

It should be noted that even though an embodiment of the present invention describes three co-axially nested booms, the number of booms may be more or less, and the method of extension may be any combination of hydraulics and/or manual extension means.

The extendable boom section 16 is coupled to the skid steer loader 12. The extendable boom section 16 may be coupled to the skid steer loader 12 by a variety of different methods. In the embodiment depicted in the Figures, the extendable boom section 16 is coupled to a support plate 30. The extendable boom section 16 is generally welded to a lower central section of the support plate. The support plate 30 is used to support and couple the device 10 to the skid steer loader 12. One or more support arms 31 may be used to provide additional support and for securing the extendable boom section 16 to the support plate 30. Each support arm 31 has a first end which is coupled to the support plate 30 and a second end coupled to the extendable boom section 16.

The support plate 30 is coupled to a pair of lifting arms 32 of the skid steer loader 12. The support plate 30 is generally coupled to the pair of lifting arms 32 by a pair of coupling bolts 34. However, this should not be seen as to limit the scope of the present invention. Other coupling devices may be used to attach the support plate 30 to the pair of lifting arms 32.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A device for allowing a skid steer loader to function as a small movable crane comprising:
a boom member having a first end removably coupled to the skid steer loader; and
a load attachment mechanism coupled to a second end of the boom member for attaching objects to the boom member for the skid steer loader to lifted.

2. A device for allowing a skid steer loader to function as a small moveable crane in accordance with claim 1 wherein the boom member is coupled to a hydraulic system of the skid steer loader.

3. A device for allowing a skid steer loader to function as a small moveable crane in accordance with claim 1 wherein the boom member is an extendable boom.

4. A device for allowing a skid steer loader to function as a small moveable crane in accordance with claim 3 wherein the extendable boom comprises:
a first boom member removably coupled to the skid steer loader;
a second extendable boom member retractably coupled to the first boom member wherein the second boom member retracts into the first boom member.

5. A device for allowing a skid steer loader to function as a small moveable crane in accordance with claim 3 wherein the extendable boom further comprises a third extendable boom member retractably coupled to the first boom member wherein the third boom member retracts into the first boom member.

6. A device for allowing a skid steer loader to function as a small moveable crane in accordance with claim 1 further comprising a support plate removably coupled to the skid steer loader wherein the boom member is permanently coupled to the support plate.

7. A device for allowing a skid steer loader to function as a small moveable crane in accordance with claim 6 wherein the support plate is removably coupled to a pair of lifting arms on the skid steer loader.

8. A device for allowing a skid steer loader to function as a small moveable crane in accordance with claim 6 further comprising a plurality of support arms wherein each support arm has a first end coupled to the support plate and a second end coupled to the boom member.

9. A device for allowing a skid steer loader to function as a small movable crane comprising:
a support plate removably coupled to the skid steer loader;
an extendable boom member coupled to a hydraulic system of the skid steer loader and having a first end coupled to the support plate; and
a load attachment mechanism coupled to a second end of the boom member for attaching objects to the boom member for the skid steer loader to lifted.

10. A device for allowing a skid steer loader to function as a small moveable crane in accordance with claim 9 wherein the extendable boom member comprises:
a first boom member removably coupled to the skid steer loader;
a second extendable boom member retractably coupled to the first boom member wherein the second boom member retracts into the first boom member.

11. A device for allowing a skid steer loader to function as a small moveable crane in accordance with claim 10 wherein the extendable boom further comprises a third extendable boom member retractably coupled to the first boom member wherein the third boom member retracts into the first boom member.

12. A device for allowing a skid steer loader to function as a small moveable crane in accordance with claim 9 wherein the extendable boom member is permanently coupled to the support plate.

13. A device for allowing a skid steer loader to function as a small moveable crane in accordance with claim 9 wherein the support plate is removably coupled to a pair of lifting arms on the skid steer loader.

14. A device for allowing a skid steer loader to function as a small moveable crane in accordance with claim 9 further comprising a plurality of support arms wherein each support arm has a first end coupled to the support plate and a second end coupled to the boom member.

15. A method for allowing a skid steer loader to function as a small movable crane comprising:
providing a support plate that is removably coupled to the skid steer loader;
providing an extendable boom member coupled to a hydraulic system of the skid steer loader and having a first end coupled to the support plate; and
providing a load attachment mechanism coupled to a second end of the boom member for attaching objects to the boom member for the skid steer loader to lifted.

16. The method of claim 15 wherein the step of providing an extendable boom member comprises the steps of:
providing a first boom member removably coupled to the skid steer loader;
providing a second extendable boom member retractably coupled to the first boom member wherein the second boom member retracts into the first boom member.

17. The method of claim 15 further comprising the step of removably coupling the support plate to a pair of lifting arms on the skid steer loader.

18. The method of claim 15 further comprising the step of providing a plurality of support arms wherein each support arm has a first end coupled to the support plate and a second end coupled to the boom member.
